(19) United States
(12) Patent Application Publication
(10) Pub. No.: US 2018/0003505 A1
(43) Pub. Date: Jan. 4, 2018

(54) VEHICLE LOCALIZATION SYSTEM AND VEHICLE LOCALIZATION METHOD

(71) Applicant: DENSO CORPORATION, Kariya-city (JP)

(72) Inventors: Kojiro TATEISHI, Kariya-city (JP); Naoki KAWASAKI, Nishio-city (JP); Shunsuke SUZUKI, Kariya-city (JP); Hiroshi MIZUNO, Kariya-city (JP)

(21) Appl. No.: 15/637,156

(22) Filed: Jun. 29, 2017

(30) Foreign Application Priority Data
Jul. 4, 2016 (JP) 2016-132605

(51) Int. Cl. G01C 21/00; G06K 9/00; G01C 21/34; G06K 9/46; G06T 7/70

(52) U.S. Cl. CPC G01C 21/005; G06K 9/4604; G06T 7/70; G01C 21/34; G06K 9/00805

(57) ABSTRACT

A vehicle localization system is provided which localizes a system-equipped vehicle. The vehicle localization system determines a position of the system-equipped vehicle on a map using a map matching technique. The vehicle localization system also calculates a variation in arrangement of feature points (e.g., edge points) of a roadside object around the system-equipped vehicle in a captured image and corrects the calculated position of the system-equipped vehicle on the map using the variation in arrangement of the feature points. This ensures a required accuracy in localizing the system-equipped vehicle.

### CROSS REFERENCE TO RELATED DOCUMENT

The present application claims the benefit of priority of Japanese Patent Application No. 2016-132605 filed on Jul. 4, 2016, the disclosure of which is incorporated herein by reference.

### BACKGROUND

### 1 Technical Field

The invention relates generally to a vehicle localization system designed to localize a moving vehicle on a map and a vehicle localization method thereof.

### 2 Background Art

Driving safety support systems are known which work to refer to a road on which a vehicle equipped with this system is moving using a map and support driving of the vehicle along the road on the map. Driving the vehicle along a road recorded on an environment map usually requires high-accuracy localization of the vehicle on the map. To this end, vehicle localization systems have been proposed which utilize GPS or an output from a vehicle speed sensor to localize a moving vehicle.

Japanese Patent First Publication No. 2007-178271 teaches a vehicle localization system which is engineered to use the position of a feature (also called a landmark) as registered at a location where a vehicle is now moving on a map and the position of a feature in an image captured by an imaging device mounted in the vehicle to localize the vehicle. Specifically, when detecting a given feature located around the road in the captured image, the vehicle localization system looks up the position of the detected feature on the map to localize the vehicle on the map.

In a case where a roadside object, such as a curb on the side of a road, is used to localize the vehicle, there is a probability that it is impossible for the vehicle localization system to correctly detect such a roadside object. For instance, when the roadside object is overhung with vegetation, the vehicle localization system may determine such vegetation as being the roadside object registered on the map. Alternatively, when the roadside object has a complicated shape, it may result in a decreased accuracy in detecting the roadside object. Incorrect detection of the roadside object will result in an error of the vehicle localization system in localizing the vehicle.

### SUMMARY

It is therefore an object to provide a vehicle localization system which is designed to localize a vehicle on a map using a roadside object and capable of minimizing a deterioration of accuracy of the localization.

According to one aspect of the disclosure, there is provided a vehicle localization system which works to localize on a road a system-equipped vehicle in which this system is mounted. The vehicle localization system comprises: (a) a vehicle position calculator which calculates a vehicle position that is a position of the system-equipped vehicle on a map using a map-matching technique; (b) a feature detector which detects a roadside object existing around the system-equipped vehicle and produces an output indicative thereof; (c) a feature extractor which analyzes the output from the feature detector to extract feature points of the roadside object which are arranged in a lengthwise direction of the road; (d) a variation calculator which calculates a variation in arrangement of the feature points in a lateral direction of the system-equipped vehicle; and (e) a corrector which corrects the vehicle position, as calculated by the vehicle position calculator, based on the variation, as calculated by the variation calculator.

When a roadside object existing around the system-equipped vehicle is not correctly detected, it may result in an error in localizing the system-equipped vehicle using a location of the roadside object on the map. For instance, when the roadside object is partially covered with grass or trees or it has a complicated shape, it will be a factor causing a decrease in accuracy when detecting the roadside object. The vehicle localization system is designed to calculate the variation in arrangement of the feature points of the roadside object in the lateral direction of the system-equipped vehicle for determining whether the roadside object has been correctly detected or not and then correct the vehicle position as a function of a degree of the variation in arrangement of the feature points, thereby ensuring a required accuracy in localizing the system-equipped vehicle.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a block diagram which illustrates a vehicle localization system according to an embodiment;

FIG. 2(a) is a view which demonstrates an image of a forward view from a system-equipped vehicle for detecting roadside objects;

FIG. 2(b) is an overhead view of a system-equipped vehicle in relation to FIG. 2(a);

FIG. 2(c) is a view which demonstrates an image of a forward view from a system-equipped vehicle for detecting roadside objects; FIG. 2(d) is an overhead view of a system-equipped vehicle in relation to FIG. 2(b);

FIG. 3 is a view which demonstrates an example of a map used in the vehicle localization system of FIG. 1;

FIG. 4 is a flowchart of a program executed by the vehicle localization system of FIG. 1 to correct a location of a system-equipped vehicle;

FIG. 5 is a flowchart of a program executed to calculate a variance of feature points of a roadside object;

FIG. 6(a) is an overhead view of a system-equipped vehicle which illustrates an example of calculating a variance of feature points of a roadside object;

FIG. 6(b) is a vertical section taken along the line A-A in FIG. 6(a);

FIG. 7(a) is a view which demonstrates an example of calculating a variance of feature points of a roadside object;

FIG. 7(b) is a histogram whose horizontal axis represents a distance between each feature point and a lane line of a road and vertical line represents the number of the feature points;

FIG. 8 is a flowchart of a program executed to correct a position of a system-equipped vehicle;

FIG. 9 is an overhead view of a system-equipped vehicle which demonstrates how to calculate a width of a road;

FIG. 10 is a flowchart of a program to calculate a variance of feature points according to the second embodiment;

FIG. 11 is an overhead view of a system-equipped vehicle which demonstrates how to calculate a variance of feature points in the second embodiment;

FIG. 12 is a flowchart of a program executed to correct a location of a system-equipped vehicle according to the third embodiment;

FIG. 13 is a view which illustrates a relation between a variance of feature points and a length of a feature extracting zone;

FIG. 14(a) is an overhead view of a system-equipped vehicle which illustrates how to calculate a variant of feature points in the third embodiment; and

FIG. 14(b) is a view which demonstrates how to correct a location of a system-equipped vehicle in the third embodiment.

### DESCRIPTION OF THE PREFERRED EMBODIMENTS

A vehicle control system equipped with a vehicle localization system according to embodiments will be described below with reference to the drawings. Throughout the drawings, like reference numbers refer to like parts in several embodiments. A roadside object, as referred to in this disclosure, represents a visual feature (also called a landmark) or three-dimensional object, such as a curbstone, a guardrail, or a road wall (e.g., a noise barrier), which usually exists on a side of a road and may be used to specify the configuration of the road.

### First Embodiment

The vehicle localization system of this embodiment is implemented by part of the vehicle control system 100. The vehicle control system 100 is engineered to use the position of a vehicle equipped with the vehicle control system 100 (which will also be referred to below as a system-equipped vehicle) calculated by the vehicle localization system to control driving of the system-equipped vehicle.

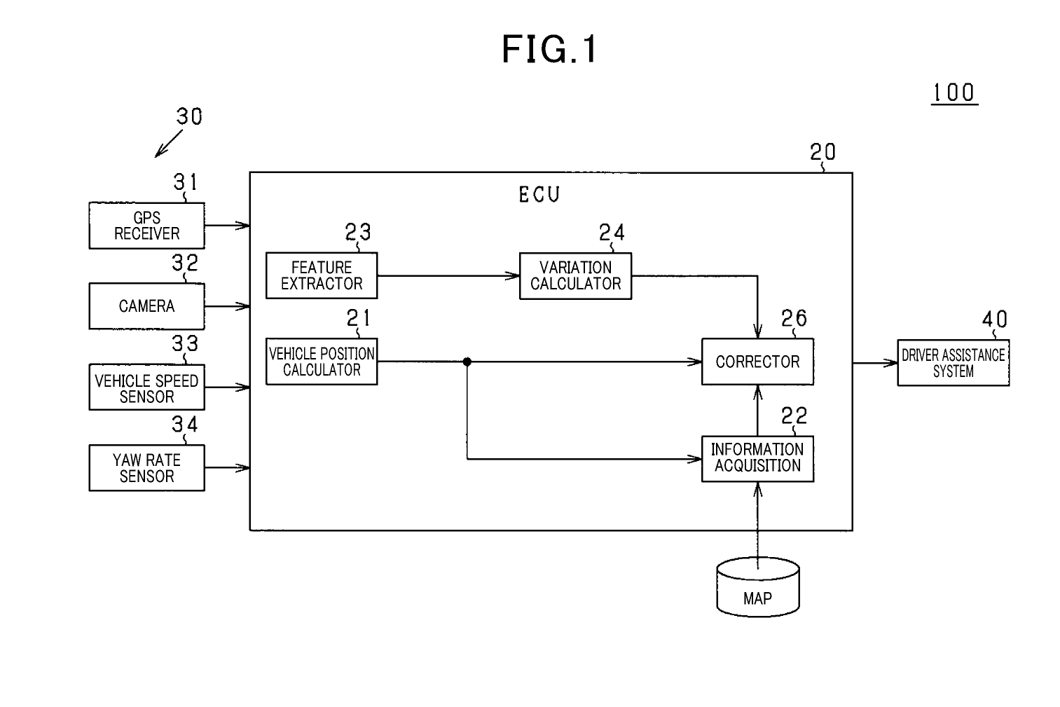

The structure of the vehicle control system 100 will first be discussed with reference to FIG. 1. The vehicle control system 100 is equipped with various types of sensors 30, the ECU 20 working as the vehicle localization system, and the driver-assistance system 40.

The sensors 30 include the GPS receiver 31, the camera 32, the vehicle speed sensor 33, and the yaw rate sensor 34.

The GPS receiver 31 works as part of a known Global Navigation Satellite System (GNSS) to receive a radio signal as GPS information which is outputted from a satellite. The GPS information includes the location of the satellite and the time (which will also be referred to as a signal output time below) when the radio signal has been outputted from the satellite. The GPS receiver 31 uses a difference between time when the GPS information has been received and the signal output time included in the GPS information to calculate a distance between the satellite and the system-equipped vehicle CS. The GPS receiver 31 then outputs the derived distance and location (i.e., coordinates x, y, and z) of the satellite to the ECU 20.

The camera 32 functions as a feature detector to capture an image of a forward view of the system-equipped vehicle CS in a direction of travel thereof. The camera 32 is implemented by a CCD camera, a CMOS image sensor, or a near-infrared camera and mounted in the system-equipped vehicle CS to have an imaging direction oriented forward from the system-equipped vehicle CS. Specifically, the camera 32 is located at the center of a width of the system-equipped vehicle CS. For example, the camera 32 is secured to a rearview mirror of the system-equipped vehicle CS and works to capture an image over a given angle range in the forward direction of the system-equipped vehicle CS. The camera 32 may be designed as a compound-eye camera to three-dimensionally localize an object.

The vehicle speed sensor 33 is secured to an axle through which power or drive torque is transmitted to wheels of the system-equipped vehicle CS. The vehicle speed sensor 33 works to produce an output as a function of rotating speed of the axle. The ECU 20 analyzes the output from the vehicle speed sensor 33 to determine the speed of the system-equipped vehicle CS. The yaw rate sensor 34 measures a yaw rate of the system-equipped vehicle CS, that is, an actual angular velocity of the system-equipped vehicle CS around the center of gravity thereof.

The ECU 20 is implemented by a computer equipped with a CPU, a ROM, and a RAM. The CPU executes programs stored in a memory to function as logical units shown in FIG. 1.

The ECU 20 works to determine the position (i.e., degrees of longitude and latitude) of the system-equipped vehicle CS on a pre-built map. Specifically, the ECU 20 analyzes the output from the GPS receiver 31 to calculate the position of the system-equipped vehicle CS on the map and correct the calculated position using a map-based position of a nearby roadside object to determine the position of the system-equipped vehicle CS (which will also be referred to below as a vehicle position CP.

The driver-assistance system 40 works to use the vehicle position CP derived by the ECU 20 to control traveling of the system-equipped vehicle CS. For instance, the driver-assistance system 40 calculates a future position of the system-equipped vehicle CS as a function of the vehicle position CP, the speed of the system-equipped vehicle CS, and the yaw rate of the system-equipped vehicle CS and then uses the calculated future position and a result of analysis of the road on which the system-equipped vehicle CS is traveling to determine whether there is a probability that the system-equipped vehicle CS will cross a lane marking on the road or not. When the system-equipped vehicle CS is determined to be likely to move cross the lane marking, the driver-assistance system 40 warns the driver using, for example, a display with a visual alarm or a speaker with an audible alarm which is mounted in system-equipped vehicle CS. Alternatively, in a case where the driver-assistance system 40 is equipped with a driving assist feature, the driver-assistance system 40 may add torque to a steering device of the system-equipped vehicle CS when the system-equipped vehicle CS is determined to be likely to move out of the lane marking.

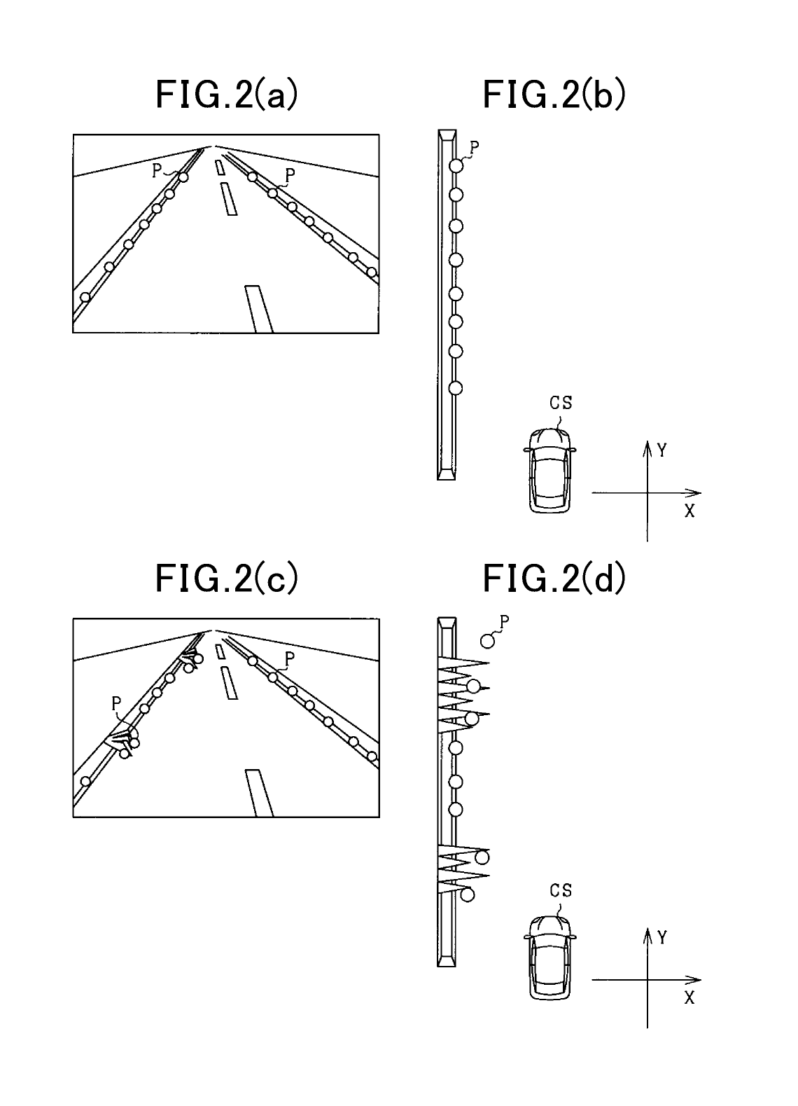

FIGS. 2(a) and 2(c) illustrate images captured by the camera 32. FIGS. 2(b) and 2(d) are overhead views of the system-equipped vehicle CS.

Use of a roadside object, such as a curb on the side of a road, for determining the vehicle position CP may result in a failure in detecting the roadside object correctly in the ECU 20. In the case, as illustrated in FIG. 2(a) or 2(b), where roadside objects arranged along sides of the road are correctly detected, edge points P (i.e., feature points) of the roadside objects, the edge points P, as extracted from the roadside objects, vary less in a width-wise direction (i.e., an x-direction) of the system-equipped vehicle CS. Alternatively, in the examples illustrated in FIGS. 2(c) and 2(d) where some of the roadside objects are covered with grass or trees, there is a probability that the grass or trees are detected erroneously as roadside objects registered on the map, which results in an increased variation in arrangement of the detected edge points P in the width-wise direction of the system-equipped vehicle CS. In a case where the roadside objects have complicated shapes, it may also result in a decrease in accuracy in specifying the roadside objects, thereby resulting in an increased variation in arrangement of the detected edge points P. Such a variation in arrangement of the edge points P will result in decreased accuracy in determining the vehicle position CP. In order to alleviate this problem, the ECU 20 is engineered to correct the calculated vehicle position CP as a function of a variation in arrangement of the edge points P.

Referring back to FIG. 1, the ECU 20 includes the vehicle position calculator 21. The vehicle position calculator 21 works to estimate or calculate the vehicle position CP on the map using map-matching techniques. The map-matching is to match the location of the system-equipped vehicle CS to a position on a road registered on the map using GPS positioning information or records of past tracks of the system-equipped vehicle CS.

The information acquiring unit 22 works to acquire information about roads around the system-equipped vehicle CS from the map based on the vehicle position CP derived by the vehicle position calculator 21. The map has road information representing properties of features existing around the vehicle position CP and is stored in the memory of the ECU 20. The ECU 20 may obtain another map from a server, not shown, through a network.

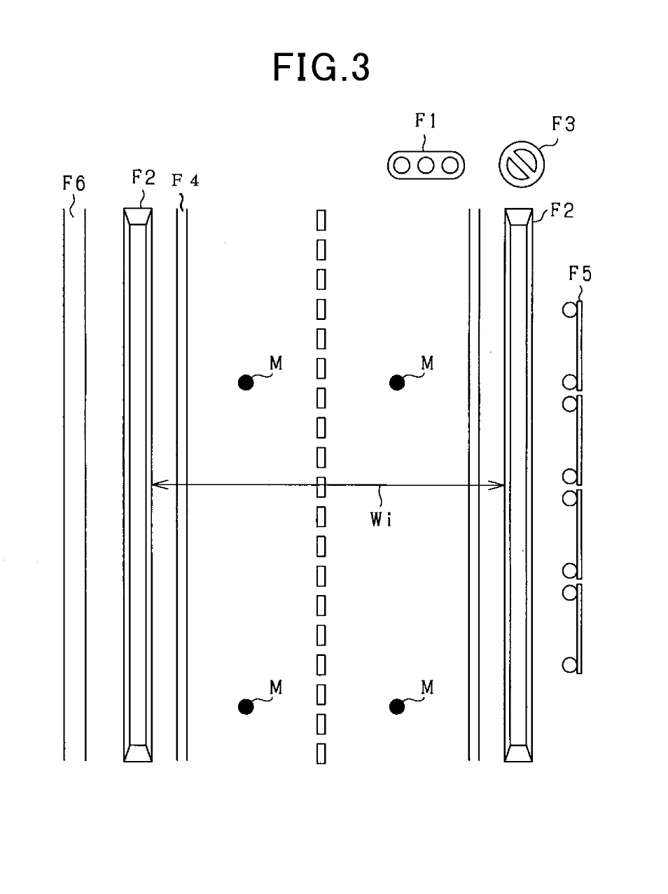

The road information stored in in the map includes geometric information which represents shapes and positions (e.g., degrees of longitude and latitude) of features on the road and property information which is stored in relation to the geometric information. FIG. 3 demonstrates a traffic light Fl, a curb F2, a road sign F3 above a road surface, lane markings F4, a guardrail F5, and a road wall F6. In this embodiment, of these features on the sides of the road, the curb F2, the guardrail F5, and the road wall F6 are used as the roadside objects which are useful to specify the configuration of the road in a lengthwise direction thereof.

The map also stores therein links which represent surfaces of roads and nodes which represent junctions of the links. The map has information about relations among locations of the nodes and the links, connections between the nodes and the links, and features existing around the nodes or the links. Additionally, each of the links stores therein relations among coordinates of center positions M of lanes which are defined at preselected interval away from each other, the width Wi of the road, and the number of lanes. In the example of FIG. 3, the center positions M are defined as centers of width of each lane which are located at given interval away from each other in the lengthwise direction of the lane.

The ECU 20 also includes the feature extracting unit 23, the variation calculator 24, and the correcting unit 26. The feature extracting unit 23 extracts the edge points P of the roadside objects existing around the system-equipped vehicle CS from an image captured by the camera 32. For instance, the feature extracting unit 23 uses a known edge extraction filter to extract pixels from the image which have a gray level gradient greater than a given value as representing each of the edge points P.

The variation calculator 24 analyzes the edge points P arranged along the length of the road and then calculates a degree of variation in arrangement of the edge points P in the width-wise direction (i.e., the lateral direction) of the system-equipped vehicle CS. Specifically, the variation calculator 24 derives a variance V of locations of the edge points P in the lateral direction of the system-equipped vehicle CS as the degree of variation in arrangement of the edge points P.

The correcting unit 26 works to correct the vehicle position CP predicated by the vehicle position calculator 21 as a function of a map-based position of the roadside object whose edge point P has been extracted. Specifically, the correcting unit 26 corrects the vehicle position CP using the degree of variation in feature arrangement, as determined by the variation calculator 24.

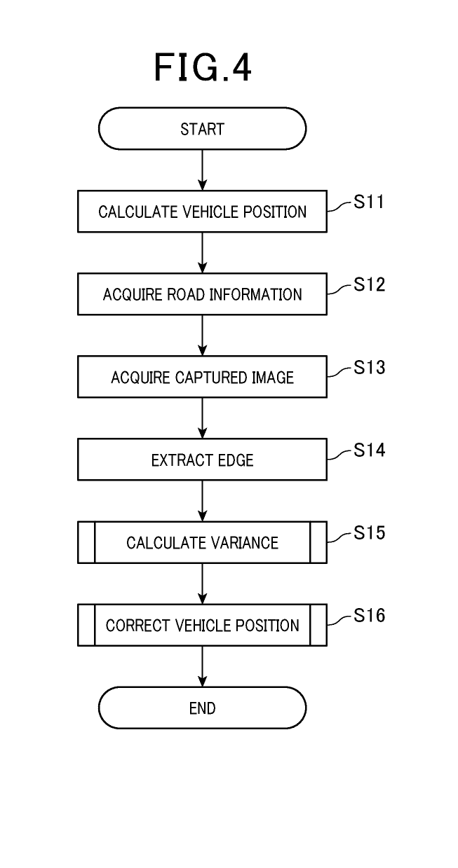

FIG. 4 is a flowchart of a program executed by the ECU 20 to specify the vehicle position CP. The program is performed in a given cycle.

After entering the program, the routine proceeds to step S11 wherein the vehicle position CP on the map is calculated using the GPS information derived by the GPS receiver 31. Specifically, the operation in step S11 functions as a vehicle position calculator to perform known map-matching to estimate the vehicle position CP.

The routine proceeds to step S12 wherein the road information around the vehicle position CP is acquired from the map. For instance, the ECU 20 obtains from the map the shape and location of the roadside object existing in a given range centered on

The routine proceeds to step S13 wherein an image of a forward view, as captured by the camera 32, is derived. The routine then proceeds to step S14 wherein the edge points P of roadside objects are extracted from the captured image. The operation in step S14 functions as a feature extractor.

The routine proceeds to step S15 wherein the variance V of locations (i.e., a variation in arrangement) of the edge points P, as arranged along the length of the road, in the lateral direction of the system-equipped vehicle, is calculated.

Specifically, the ECU 20 defines a plurality of vertical zones separate in a height-wise direction (i.e., a vertical direction) of the system-equipped vehicle CS in the captured image. The ECU 20 selects, of the vertical zones in which the edge points P have been extracted, one which is closest to the center of the road and then uses the edge points P in the selected vertical zone as an edge group for calculating the variance V. The operation in step S15 function as variation calculator.

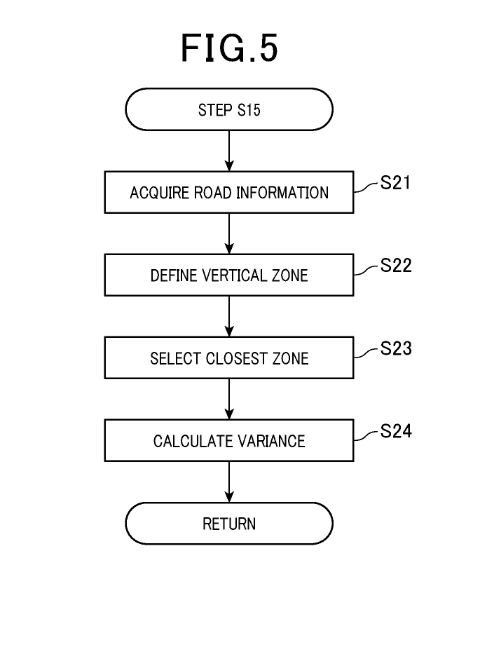

The operation in step S15 will be described in detail with reference to FIG. 5.

First, in step S21, a boundary line (i.e., a lane line) of the road on which the system-equipped vehicle CS exists and the center position M on a lane in which the system-equipped vehicle CS is now cruising are acquired from the map as the road information. The road on which the system-equipped vehicle CS is now traveling is specified using the vehicle position CP calculated in step S11.

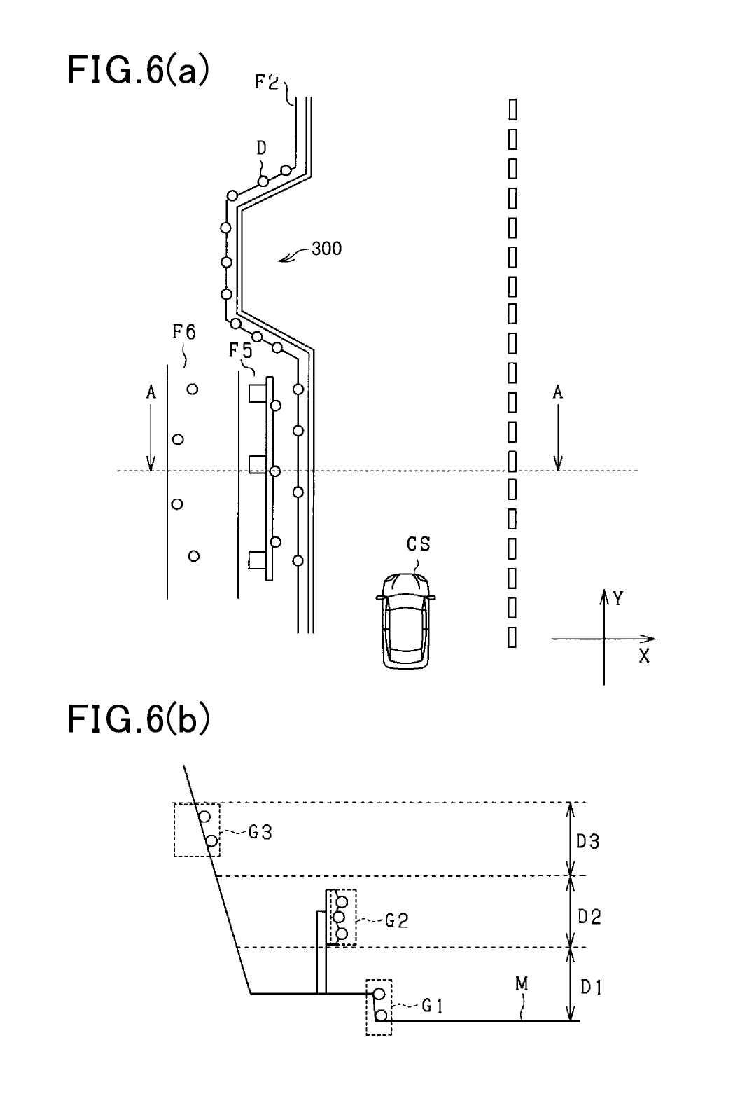

The routine proceeds to step S22 wherein vertical zones for use in grouping the edge points P are defined. FIG. 6(a) is an overhead view of the system-equipped vehicle CS from above. FIG. 6(b) is a vertical section, as taken along the line A-A in FIG. 6(a), which demonstrate arrangement of the edge points P in the height-wise direction of the system-equipped vehicle CS. In the example of FIG. 6(a), the curb F2, the guardrail F5, and the road wall F6 are arranged as roadside objects around the system-equipped vehicle CS. In the example of FIG. 6(b), the ECU 20 defines the zones D1, D2, and D3 adjacent each other in the height-wise direction of the system-equipped vehicle CS.

The zones D1 to D3 may alternatively be defined adjacent each other in the lateral direction of the system-equipped vehicle CS around the roadside. For instance, the roadside, as illustrated in FIG. 6(a), is divided into several zones which are arranged from the boundary line derived in step S21 in the lateral direction (i.e., the x-direction in FIG. 6(a)).

The routine proceeds to step S23 wherein of the zones of which the edge points P have been extracted, one which is closest to the center position M of the lane in which the system-equipped vehicle CS is traveling is selected. The edge points P in the selected one of the zones are defined as an edge group for use in calculating the variance V. In the example of FIG. 6(b), the zone D1 has an edge group G1 of the curb F2. The zone D2 has an edge group G2 of the guardrail F5. The zone D3 has an edge group G3 of the road wall F6. The edge points P are detected in all the zones D1 to D3. The edge group in one of the zones D1 to D3 which is located closest to the center position M of the system-equipped vehicle CS is, therefore, the edge group G1. The ECU 20 selects the edge points P of the edge group G1 in the zone D1 for correcting the vehicle position CP. The operation in step S23 functions as a feature selector.

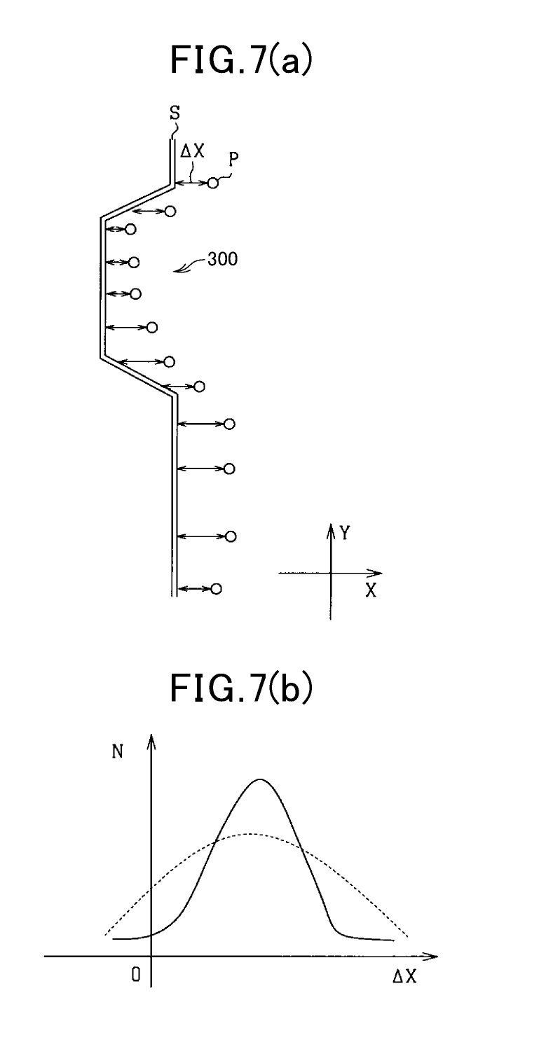

The routine then proceeds to step S24 wherein the variance V of the edge points P in the edge group selected in step S23 is calculated. In a case where there is a special area, such as a safety zone or an emergency area denoted by numeral 300 in FIG. 6(a), which usually results in a great change in geometric shape of the road, locations of roadside objects in that area are different from those in another area in the road in the width-wise direction of the road (i.e., the system-equipped vehicle CS) depending upon the configuration of that area, which will undesirably lead to a great variation in arrangement of the edge points P. The ECU 20, therefore, calculates, as illustrated in FIG. 7(a), the variance V of distances ΔX of the edge points P from the boundary line S derived in step S21 in the width-wise direction (i.e., the x-direction) of the system-equipped vehicle CS.

For instance, the variance V is derived according to Eqs. (1) and (2) below.

V=Σ(ΔXî2)/N (1)

ΔXi=Xpi−m (2)

where “N” is the number of the edge points P in the selected zone, “i” is an identifier that is one of numerals 1 to N and identifies each of the edge points P along the length of the road, “̂” represents a power (i.e., ̂2 is the square), and “Σ” represents the summation of distances Xi in the selected zone, and where “Xpi” represents a location of each edge point P in the x-direction, and “m” represents an expected value of the edge point P, that is, a location of the edge point P on the boundary line S of the road.

FIG. 7(b) is a histogram whose horizontal axis represents the distance ΔX between each edge point P and the boundary line S of the road and vertical line represents the number of the edge points P. The histogram shows that when a variation of the distances ΔX in the zone is, as indicated by a solid line, smaller, the variance V will be small, while when a variation of the distances ΔX in the zone is, as indicated by a broken line, greater, the variance V will be great.

After step S24, the routine proceeds to step S16 in FIG. 4 wherein the vehicle position CP is corrected using the variance V calculated in step S15. The operation in step S16 functions as a corrector.

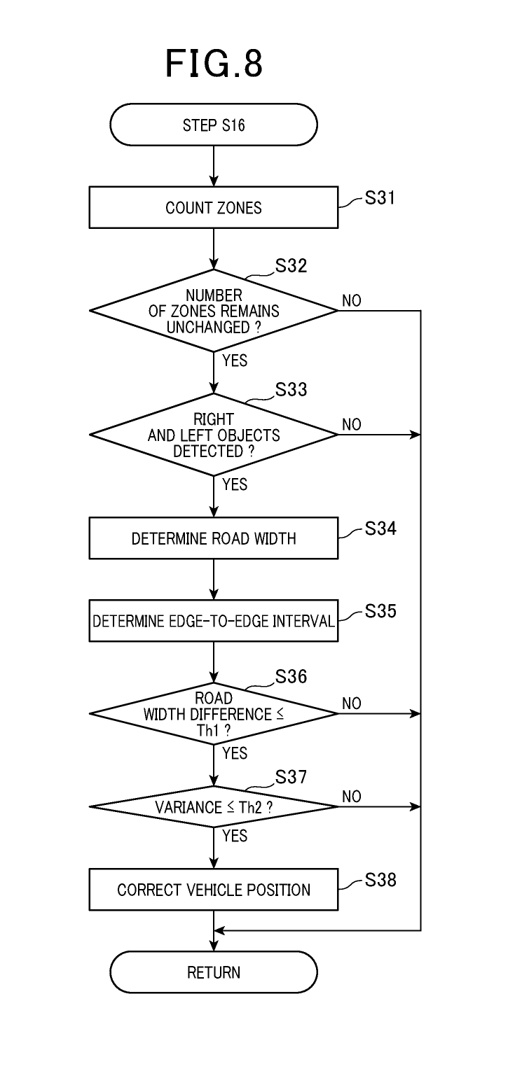

The operation in step S16 will be described in detail with reference to FIG. 8.

First, in step S31, of the zones which are defined in step S15, ones in which the edge points P have been extracted are counted. The number of the zones in which the edge points P have been extracted will be also referred to below as a zone number DN. When the zone number DN has changed, it may result in a possibility that the variance V has been calculated using the edge points P detected in selected ones of the zones in a first section of the road on which the system-equipped vehicle CS is traveling and subsequently calculated using the edge points P detected in different zones in a second section different from the first section of the road. For instance, the edge points P of the edge group G1 which are extracted from a roadside object located at a lower level in the height-wise direction in FIG. 6(b) usually tend to appear intermittently as compared with the edge points P of the edge group G2 or G3 which are extracted from a roadside object located at a higher level. If, therefore, the edge group G1 has stopped being detected while the system-equipped vehicle CS is traveling, it may cause the edge group G2 to be closest to the center position M of the lane, so that there are two periods of time: one being a first period of time in which the variance V is calculated using the edge group G1, and one being a second period of time in which the variance Vis calculated using the edge group G2.

After step S31, the routine proceeds to step S32 wherein it is determined whether the zone number DN is still unchanged or not. If a NO answer is obtained meaning that the zone number DN has changed, then the routine returns back to FIG. 4 to terminate calculation of the vehicle position CP. In this case, the ECU 20 concludes that the variance V has not arisen from the same type of a roadside object and does not use the variance V derived in step S15. Alternatively, of a YES answer is obtained in step S32 meaning that the variance V has arisen from the same type of a roadside object, then the routine proceeds to step S33.

In step S33, it is determined whether roadside objects are being detected on both the right and left sides of the system-equipped vehicle CS or not. For instance, when curbs exist as roadside objects both on the right and the left sides of the road on which the system-equipped vehicle CS is traveling, so that the edge points P are being extracted from images of the curbs both on the right and left sides of the road, the ECU 20 determines that the edge points P of the curb on each of the right and left sides of the road are being detected. Alternatively, when a curb and a guardrail exist on the right and left sides of the road on which the system-equipped vehicle CS is traveling, respectively, so that the edge points P are being extracted from images of both the curb and the guardrail, the ECU 20 may determine that the edge points P of the roadside objects both on the right and left sides of the road are being detected.

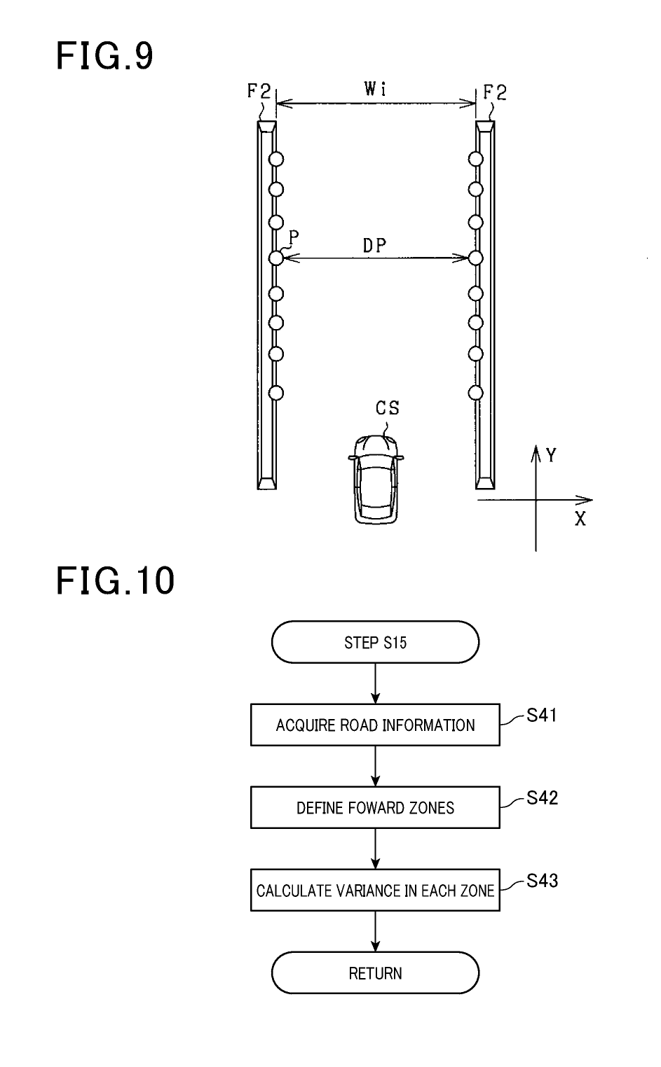

If a NO answer is obtained in step S33 meaning that the roadside objects are not detected both on the right and left sides of the system-equipped vehicle CS, then the routine terminates. Alternatively, if a YES answer is obtained in step S33, then the routine proceeds to step S34 where a width Wi of the road on which the system-equipped vehicle CS is not traveling is derived from the map. Specifically, the ECU 20, as illustrated in FIG. 9, derives the width Wi of the road registered in the map. The operation in step S34 functions as a road width calculator.

The routine proceeds to step S35 wherein a lateral edge-to-edge interval DP that is a minimum distance between the edge points P of the right and left roadside objects. In the example of FIG. 9, a distance between the edge points P of the right and left curbs F2 which are aligned in the lateral direction (i.e., the x-direction) of the lane (i.e., the system-equipped vehicle CS) is determined as the lateral edge-to-edge interval DP. The operation in step S35 functions as an interval calculator.

The routine proceeds to step S36 wherein it is determined whether a difference between the road width Wi, as derived in step S34, and the lateral edge-to-edge interval DP, as derived in step S35, is smaller than or equal to a given threshold value Th1 or not. There is a probability that the variance V, as calculated using the edge points P, does not arise from a roadside object. For instance, when the edge points Pare extracted from an object other than the roadside object, it may result in a change in the lateral edge-to-edge interval DP between the right and left roadside objects, which leads to an increase in difference between the lateral edge-to-edge interval DP and the road width Wi stored in the map. In order to eliminate an error in localizing the system-equipped vehicle CS which arises from such a change in difference between the lateral edge-to-edge interval DP and the road width Wi, the ECU 20 determines in step S36 wherein the difference between the road width Wi and the lateral edge-to-edge interval DP is smaller than or equal to the given threshold value Th1 or not for achieving accurate correction of the location of the system-equipped vehicle CS.

If a NO answer is obtained in step S36 meaning that the difference between the road width Wi and the lateral edge-to-edge interval DP is greater than the threshold value Th1 and that the variance V of the edge points P has arisen from an object other than the pre-selected roadside objects, then the routine terminates. Alternatively, if a YES answer is obtained meaning that the difference between the road width Wi and the lateral edge-to-edge interval DP is lower than or equal to the threshold value Th1 and that the variance V of the edge points P has arisen from the pre-selected roadside object, then the routine proceeds to step S37.

In step S37, it is determined whether the variance V of the edge points P is smaller than or equal to a given threshold value Vh2 or not. If a NO answer is obtained meaning that the variance V is greater than the threshold value Th2 and meaning that the roadside object is not been correctly detected, then the routine terminates, so that the vehicle position CP is not corrected in this program execution cycle.

Alternatively, if a YES answer is obtained in step S37 meaning that the variance Vis lower than or equal to the threshold value Th2, then the routine proceeds to step S38 wherein the vehicle position CP, as derived using the edge points P in one of the zones selected in step S23, is corrected. For instance, the ECU 20 calculates a first distance between the system-equipped vehicle CS and the curb F2 derived by the edge points P extracted from the captured image and a second distance between the vehicle position CP and the curb F2 calculated on the map and then determines a difference between the first distance and the second distance. The ECU 20 corrects the vehicle position CP, as calculated on the map, in the lateral direction of the system-equipped vehicle CS. Specifically, the ECU 20 alters a coordinate of the vehicle position CP in the width-wise direction of the road so as to decrease the difference between the first distance and the second distance. The routine then terminates.

The ECU 20 of the first embodiment is, as apparent from the above discussion, designed to estimate or calculate the vehicle position CP on the map using the map-matching techniques and extract the edge points P of a roadside object existing around the system-equipped vehicle CS from an output of the camera 32 mounted in the system-equipped vehicle CS. The ECU 20 derives the edge points P arranged in the lengthwise direction of the road on which the system-equipped vehicle CS is traveling and then calculates the degree of variation in arrangement of the edge points P in the lateral direction of the system-equipped vehicle CS. The ECU 20 also corrects the calculated vehicle position CP using the degree of variation in arrangement of the edge points P to finally localize the system-equipped vehicle CS. In other words, the ECU 20 (i.e., the vehicle localization system) works to analyze the variance V of the edge points P to determine whether the pre-selected roadside object has been correctly detected or not for correcting the vehicle position CP on the pre-built map, thereby enhancing the accuracy in localizing the system-equipped vehicle CS.

The ECU 20 acquires a boundary line (i.e., a lane line) of the road from the map. The boundary line extends along the length of the road. The ECU 20 then calculates the variance V using the distances ΔX between the boundary line and the respective edge points P extracted from a captured image. When there is a special area, such as a safety zone or an emergency area, which usually results in a great change in geometric shape of the road, it will result in a great change in location of the roadside object in that area in the width-wise direction of the road (i.e., the system-equipped vehicle CS). The ECU 20, therefore, derives the boundary line extending along the length of the road from the map and calculates the variance V of distances ΔX of the edge points P from the boundary line in the width-wise direction of the system-equipped vehicle CS. The use of the edge points P extracted along the boundary line of the road minimizes an undesirable great change in value of the variance V, thereby ensuring the accuracy in localizing the system-equipped vehicle CS.

The ECU 20, as described above, defines a plurality of discrete vertical zones arranged adjacent each other in the height-wise direction of the system-equipped vehicle CS in the captured image, but however, may alternatively define a plurality of lateral zones arranged adjacent each other around the roadside in the lateral direction of the road (i.e., the width-wise direction of the system-equipped vehicle CS). The ECU 20 may alternatively define around the roadside a plurality of zones which are arranged in a matrix and each of which has a given height and a given width. The ECU 20 selects, of the zones in which the edge points P have been extracted, one which is closest to the center of the lane on which the system-equipped vehicle CS is traveling and then uses the edge points P in the selected zone as an edge group for calculating the variance V.

When a plurality of roadside objects exist in the height-wise direction of the system-equipped vehicle CS or a roadside object(s) is inclined relative to the height-wise direction, it may cause the edge points P to have the same level in the height-wise direction, but have locations different from each other in the lateral direction of the system-equipped vehicle CS, which leads to an undesirable increased value of the variance V. In order to alleviate such a problem, the ECU 20 is engineered to use the edge points P in one of the zones which is located closest to the center position M of the lane for calculating the variance V. This ensures a desirable accuracy in correcting the calculated location of the system-equipped vehicle CS even when the extracted edge points P are arranged in the width-wise direction of the system-equipped vehicle CS.

When the edge points P have been detected in two or more of the zones, and the number of the zones (i.e., the zone number DIV) in which the edge points P have been detected has changed with time, the ECU 20 determines a period of time for which the zone number DN remained unchanged and uses the variance V, as calculated in that period of time, to correct the vehicle position CP. A roadside object which is located at a lower level in the height-wise direction of the system-equipped vehicle CS usually result in a decrease in accuracy in detecting such a roadside object as compared with a roadside object which is located at a higher level in the height-wise direction, which leads to a possibility that the edge points P are extracted from different types of roadside objects in a period of time in which the system-equipped vehicle CS is traveling. Such a disadvantage is eliminated in this embodiment. Specifically, when a condition where the number of the zones in which the edge points P have been detected (i.e. the zone number DN) remains unchanged is met, the ECU 20 uses the edge points Pin a selected one of the zones to correct the position of the system-equipped vehicle CS. This eliminates an error in calculating the variance V which results from the edge points P extracted from different kinds of roadside objects in a selected one of the zones.

The ECU 20 determines the width Wi of the road on which the system-equipped vehicle CS is traveling. When roadside objects exist both on the right and left sides of the system-equipped vehicle CS, the ECU 20 calculates the lateral edge-to-edge interval DP between the edge points P extracted from the right and left roadside objects and derives a difference between the road width Wi and the lateral edge-to-edge interval DP. When such a difference is in a given range, the ECU 20 works to correct the vehicle position CP as a function of the variance V. When the edge points P are extracted from an object other than the above described roadside objects, it may result in an increase in difference between the lateral edge-to-edge interval DP, as derived from the edge points P of the right and left roadside objects, and the road width Wi of a road on which the system-equipped vehicle CS is traveling. In order to alleviate such a problem, the ECU 20 corrects the position of the system-equipped vehicle CS using the variance V when the difference between the road width Wi and the lateral edge-to-edge interval DP lies within a given range. In other words, the ECU 20 corrects the position of the system-equipped vehicle CS when the edge points P are extracted correctly from the right and left roadside objects, thereby ensuring the accuracy in localizing the system-equipped vehicle CS.

### Second Embodiment

The vehicle localization system of the second embodiment is engineered to define zones in which the edge points P are to be extracted from a captured image as a function of a distance between the system-equipped vehicle CS and a roadside object existing in the forward direction of the system-equipped vehicle CS and selects one(s) of the zones in which the variance V of the edge points P is expected to have a value suitable for correcting the vehicle position CP.

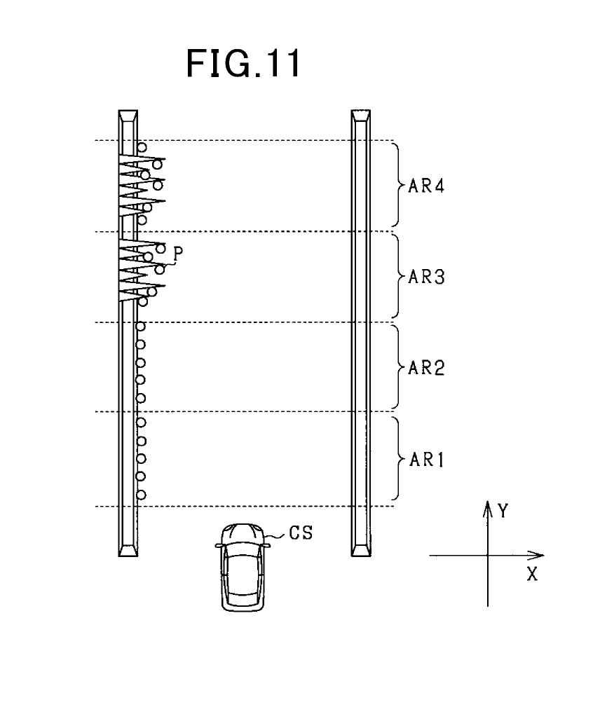

FIG. 10 is a flowchart of a program executed by the ECU 20 in step S15 of FIG. 4 to calculate the variance V. FIG. 11 illustrates how to calculate the variance V.

First, in step S41, the road information is derived. Specifically, the ECU 20 obtains a boundary line (i.e., a lane line) of the road on which the system-equipped vehicle CS is traveling from the map as the road information.

The routine then proceeds to step S 42 wherein forward zones are defined as a function of a distance from the system-equipped vehicle CS in a direction of travel of the system-equipped vehicle CS (i.e., a y-direction). In an example of FIG. 11, four forward zones AR1 to AR4 which are different in distance between themselves and the system-equipped vehicle CS are defined. In this embodiment, the forward zones have the same dimension in the direction of travel of the system-equipped vehicle CS (i.e., the lengthwise direction of the road).

The routine proceeds to step S43 wherein the variance V is calculated in each of the forward zones. Specifically, the ECU 20 calculates the variance V of the edge points P according to Eqs. (1) and (2), as discussed above. After step S43, the routine proceeds to step S16 in FIG. 4.

In step S16, one(s) of the forward zones is selected for correcting the vehicle position CP using values of the variance V of the edge points Pin the forward zones. The edge points Pin the selected one(s) of the forward zones are used to correct the vehicle position CP. For instance, the ECU 20 selects one of the forward zones in which the value of the variance V is the smallest and then corrects the vehicle position CP using the edge points P in the selected one(s) of the forward zones. In the example of FIG. 11, the forward zones AR1 and AR2 each have the smallest value of the variance V. The ECU 20 uses the edge points Pin the forward zones AR1 and AR2 in correcting the vehicle position CP in the same manner as described in step S16.

As apparent from the above discussion, the vehicle localization system of the second embodiment is engineered to, in the ECU 20, calculate the variance V in each of the forward zones defined on the basis of a distance from the system-equipped vehicle CS in the direction of travel of the system-equipped vehicle CS and then select one(s) of the forward zones for use in correcting the vehicle position CP based on a result of comparison among the values of the variance Vin the forward zones. The vehicle localization system then corrects the vehicle position CP using the edge points P in the selected one(s) of the forward zones and locations of those edge points P on the map. When some of the roadside objects are covered with grass or trees in a section of the road, it results in an increased variation in arrangement of the edge points P in that section, but in another section of the road, the roadside objects will be correctly detected. The vehicle localization system of this embodiment calculates the variance V in each of the forward zones defined as a function of a distance from the system-equipped vehicle CS in the direction of travel of the system-equipped vehicle CS and selects one(s) of the forward zones based on the values of the variance V in the forward zones for use in correcting the vehicle position CP. This eliminates a risk that an error in localizing the system-equipped vehicle CS arises from use of the edge points P in one(s) of the forward zones where the value of the variance V is undesirably great, thereby ensuring the accuracy in correcting the vehicle position CP.

### Third Embodiment

The vehicle localization system of the third embodiment is engineered to average locations of the edge points P extracted from a roadside object in the lateral direction of the system-equipped vehicle CS based on the variance V of the edge points P and correct the vehicle position CP using the average of the locations of the edge points P and a location of the roadside object on the map.

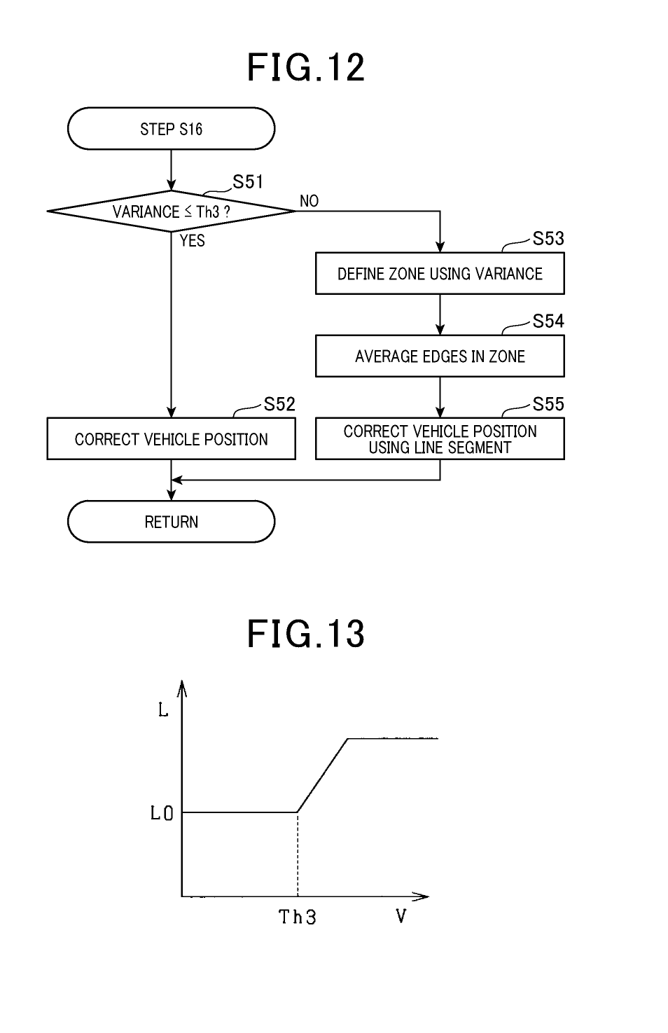

FIG. 12 is a flowchart of a program executed in step S16 of FIG. 4 by the ECU 20 to correct the vehicle position CP in the third embodiment.

In step S51, it is determined whether the variance V, as calculated in step S15 of FIG. 4, lower than or equal to a threshold value Th3 or not. If a YES answer is obtained, then the routine proceeds to step S52 wherein the vehicle position CP is corrected. Specifically, the ECU 20 calculates a deviation of each of the extracted edge points P from the roadside object on the map in the lateral direction of the system-equipped vehicle CS (i.e., the road) and corrects the vehicle position CP based on such deviations using a method, as taught in the prior art publication discussed in the introductory part of this application, the known Kalman filtering technique, or the least-square technique. These techniques to correct the vehicle position CP may be used in the above embodiments.

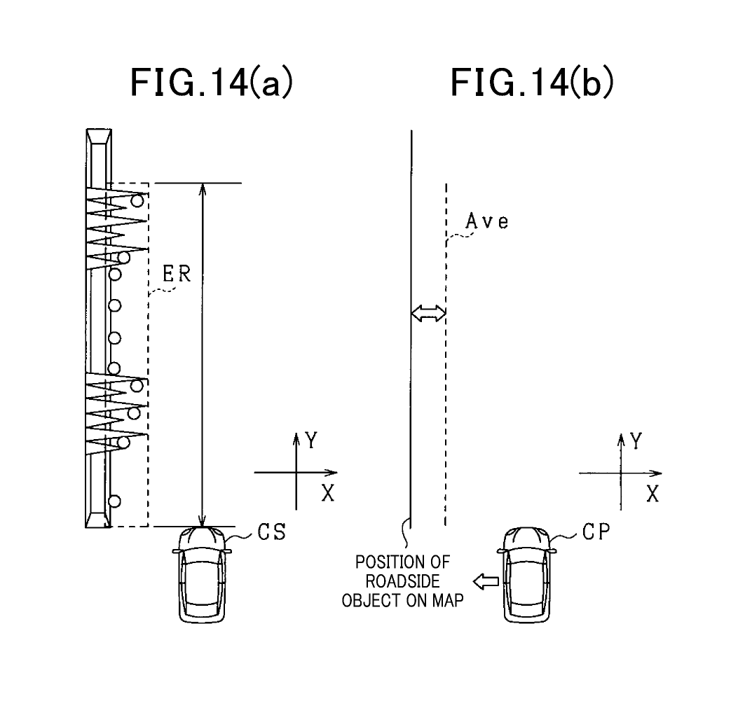

Alternatively, if a NO answer is obtained in step S51 meaning that the variance V is greater than the threshold value Th3, then the routine proceeds to step S53 wherein an edge extracting zone ER which extend in from of the system-equipped vehicle CS along the length of the road is defined for selecting the edge points P. In an example of FIG. 14(a), the edge extracting zone ER is defined which ranges between the front of the system-equipped vehicle CS and a location at a distance L away from the front of the system-equipped vehicle CS in the lengthwise direction of the road. In other words, the edge extracting zone ER has the length L from the front of the system-equipped vehicle CS. For instance, the ECU 20 stores therein a map, as illustrated in FIG. 13, which specifies a relation between the value of the variance V and the length L of the edge extracting zone ER and determines the value of the length L by look-up using such a map.

In an example of FIG. 13, when the value of the variance V is less than or equal to the threshold value Th3, the edge extracting zone ER which has a constant value of the length L is defined. When the value of the variance V exceeds the threshold value Th3, the edge extracting zone ER is defined which has the length L increasing with an increase in value of the variance V.

After the edge extracting zone ER is defined in step S53, the routine proceeds to step S54 wherein positions of the edge points Pin the lateral direction of the system-equipped vehicle CS (i.e., the x-direction) within the edge extracting zone ER derived in step S53 are averaged to define a line segment Ave. Specifically, the line segment Ave is defined which passes through the averaged value of the lateral positions of the edge points P along the length of the road. For instance, the ECU 20 defines a line segment which is the closest to all the edge points P in the edge extracting zone ER using a known least-square technique and determines the line segment as the line segment Ave, as derived by averaging the positions of the edge points P in the lateral direction of the system-equipped vehicle CS.

The routine proceeds to step S55 wherein the vehicle position CP on the map is corrected using the line segment Ave derived in the step S54 and the location of the roadside object on the map. In the example of FIG. 14(b), the ECU 20 derives a deviation of the position of the line segment Ave in the x-direction from the position of the roadside object in the x-direction on the map and then corrects the calculated vehicle position CP in the x-direction as a function of the deviation. For instance, the ECU 20 corrects the vehicle position CP so as to minimize or eliminate the deviation.

After step S54, the routine terminates the program of FIG. 4.

As apparent from the above discussion, when the value of the variance V is greater than or equal to the threshold value Th3, the ECU 20 of the third embodiment determines the edge extracting zone ER which extend along the length of the road as a function of the value of the variance V and corrects the vehicle position CP based on an average of positions of the edge points P in the lateral direction of the system-equipped vehicle CP in the edge extracting zone ER and the position of the roadside object on the map. In other words, the ECU 20 corrects the vehicle position CP using a result of averaging of the positions of the edge points P. This decreases a variation in location of the edge points P in the lateral direction of the system-equipped vehicle CS after the positions of the edge points P are averaged, thereby ensuring a desired accuracy in correcting the vehicle position CP.

### Modification

The variation in arrangement (i.e., location) of the edge points P may alternatively be calculated using a standard deviation thereof instead of the variance V. The variation may also be determined by selecting a first one of the edge points P and a second one of the edge points P. The edge points P are arranged along the length of the road. The first edge point P is the greatest in position thereof in the lateral direction of the system-equipped vehicle CS. The second edge point P is the smallest in position thereof in the lateral direction of the system-equipped vehicle CS. The variation is calculated as a function of a distance between the first and second edge points P. For instance, the ECU 20 calculates an average of positions of the edge points P in the lateral direction of the system-equipped vehicle CS and defines the right side of the average as a plus (+) side and the left side of the average as a minus (−) side in the lateral direction of the system-equipped vehicle CS. The ECU 20 determines one of the edge points P which is farthest from the average on the plus side as the first edge point P and one of the edge points P which is farthest from the average on the minus side as the second edge point P. The ECU 20 increases the variation in arrangement of the edge points P with an increase in distance or interval between the first and second edge points P.

The ECU 20 may be designed to correct the vehicle position P using a filter which variably changes a degree of smoothing operation thereof as a function of the variance V. For instance, in step S16 of FIG. 4, the ECU 20 increases the degree of smoothing in the filter with an increase in value of the variance V to increase the degree to which a variation in position of the edge points P in the lateral direction of the system-equipped vehicle CS is smoothed. The ECU 20 then corrects the vehicle position CP using a deviation of a position of the roadside object, as calculated from filtered positions of the edge points P, from that of the roadside object on the map.

The feature extractor is implemented by the camera 32, but may alternatively be realized using a laser sensor or a radar sensor which emits electromagnetic wave to detect an object.

In step S11 of FIG. 4, the vehicle position CP is calculated using an integral of an output of the vehicle speed sensor 33 in place of or in addition to the GPS information.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiment which can be embodied without departing from the principle of the invention as set forth in the appended claims.

What is claimed is:

1. A vehicle localization system which works to localize on a road a system-equipped vehicle in which this system is mounted comprising:
a vehicle position calculator which calculates a vehicle position that is a position of the system-equipped vehicle on a map using a map-matching technique;
a feature detector which detects a given roadside object existing around the system-equipped vehicle and produces an output indicative thereof;
a feature extractor which analyzes the output from the feature detector to extract feature points of the roadside object which are arranged in a lengthwise direction of the road;
a variation calculator which calculates a variation in arrangement of the feature points in a lateral direction of the system-equipped vehicle; and
a corrector which corrects the vehicle position, as calculated by the vehicle position calculator, based on the variation, as calculated by the variation calculator.

2. A vehicle localization system as set forth in claim 1, wherein the variation calculator obtains from the map a boundary line of the road extending in the lengthwise direction of the road and determines the variation in arrangement of the feature points using distances between the boundary line and the respective feature points in the lateral direction of the system-equipped vehicle.

3. A vehicle localization system as set forth in claim 1, further comprising a feature selector which defines a plurality of zones arranged around a side of the road in one of a height-wise direction and the lateral direction of the system-equipped vehicle for grouping the feature points, and wherein of the zones in which the feature points have been detected, one which is closest to a center of a lane in which the system-equipped vehicle is traveling is selected to use the feature points in the selected one of the zones in calculating the variation in arrangement of the feature points.

4. A vehicle localization system as set forth in claim 3, wherein when the feature points have been extracted in two or more of the zones, and the number of the zones in which the feature points have been extracted has changed with time, the corrector determines a period of time for which the number of the zones has remained unchanged and uses the variation in arrangement of the feature points, as calculated in that period of time, to correct the vehicle position.

5. A vehicle localization system as set forth in claim 1, further comprising a road width calculator and an interval calculator, the road width calculator working to calculate a width of the road on which the system-equipped vehicle is traveling, when roadside objects exist both on a right side and on a left side of the road, the interval calculator working to determine an interval between the roadside object on the right side of the road and the roadside object on the left side of the road using the extracted feature points, and wherein when a difference between the width of the road and the interval lies within a given range, the corrector serves to correct the vehicle position using the variation in arrangement of the feature points.

6. A vehicle localization system as set forth in claim 1, wherein the variation calculator determines the variation in arrangement of the feature points in each of forward zones as defined as a function of a distance from the system-equipped vehicle in a direction of travel of the system-equipped vehicle, and wherein the corrector selects one of the forward zones based on a result of comparison among values of the variation in arrangement of the feature points in the forward zones for use in correcting the vehicle position, the corrector working to correct the vehicle position using positions of the feature points in the selected one of the forward zones on the map.

7. A vehicle localization system as set forth in claim 1, wherein when the variation in arrangement of the feature points is greater than or equal to a given value, the corrector defines a zone in which the feature points are extracted in a lengthwise direction of the road as a function of a value of the variation, and wherein the corrector corrects the vehicle position using a result of averaging of positions of the feature points, as existing in the zone, in the lateral direction of the system-equipped vehicle and a position of the roadside object on the map.

8. A vehicle localization method which localizes on a road a system-equipped vehicle in which this system is mounted comprising:
a vehicle position calculating step of calculating a vehicle position that is a position of the system-equipped vehicle on a map using a map-matching technique;
a feature detecting step of detecting a roadside object existing around the system-equipped vehicle and produces an output indicative thereof;
a feature extracting step of analyzing the output from the feature detector to extract feature points of the roadside object which are arranged in a lengthwise direction of the road;
a variation calculating step of calculating a variation in arrangement of the feature points in a lateral direction of the system-equipped vehicle; and
a correcting step of correcting the vehicle position, as calculated by the vehicle position calculator, based on the variation, as calculated by the variation calculator.
